(19) United States
(12) Patent Application Publication
(10) Pub. No.: US 2013/0066678 A1
(43) Pub. Date: Mar. 14, 2013

(54) METHOD AND SYSTEM FOR DEMAND MODELING AND DEMAND FORECASTING PROMOTIONAL TACTICS

(71) Applicants: Brent Joseph May, Scottsdale, AZ (US); Gustavo Ayres de Castro, Scottsdale, AZ (US); Yetkin Ileri, Scottsdale, AZ (US); Mohamed Mneimneh, Scottsdale, AZ (US); Kautilya Patel, Tempe, AZ (US); Geoffrey Hutton, Scottsdale, AZ (US)

(72) Inventors: Brent Joseph May, Scottsdale, AZ (US); Gustavo Ayres de Castro, Scottsdale, AZ (US); Yetkin Ileri, Scottsdale, AZ (US); Mohamed Mneimneh, Scottsdale, AZ (US); Kautilya Patel, Tempe, AZ (US); Geoffrey Hutton, Scottsdale, AZ (US)

(21) Appl. No.: 13/228,963

(22) Filed: Sep. 9, 2011

(51) Int. Cl. G06Q 10/00

(52) U.S. Cl. 705/7.31

(57) ABSTRACT

According to some embodiments, a system and method includes receiving historical data of promotional offers associated with a product or service, the promotional offers including at least one tactic effect; receiving a request to forecast a demand for the product or service, the request including an indication of a promotional offer tactic effect; generating a demand forecast including a tactic lift for the requested promotional offer tactic effect, the demand forecast based on the at least one tactic effect contributing to the demand for the product or service; and providing an output of the generated demand forecast

### FIELD

The present disclosure relates, in general, to demand modeling and demand forecasting and, more particularly, to a system and method of demand models and demand forecasts for promotional offers including tactic effects.

### BACKGROUND

Systems and methods for demand modeling and demand forecasting are oftentimes used to estimate or predict a performance outcome of a commerce or economic system, given specific sets of relevant input data. Demand forecasts may benefit a business entity by providing new and actionable information for a product or service in terms of expected or predicted units sold, transactions completed, or revenue generated. The business entity, such as a business manager, marketer, retailer, manufacturer, distributor, and other business service providers may use the forecasted demand for the product or service in making business decisions related to the particular product or service. For example, a manufacturer may decide whether to increase (decrease) manufacturing output for a future shopping season based on a forecast of rising (lowering) demand for the manufacturer's products in that future shopping period.

In many instances demand forecasts commonly provide an indication or reporting of a total demand for a product or service in response to a particular promotional offer(s), in terms of predicted or estimated units sold and/or revenue generated based on promotional sales. This type of total demand forecast may provide some guidance to a business entity or business decision-maker as stated above. However, the total demand forecast related to a promotional offer(s) may be too broad or too “coarse” to provide a business manager or decision-maker the information with the information necessary for them to make strategic business decisions based on the promotional offer(s) associated with the demand forecast. For instance, the demand forecast may not be sufficient to inform a business manager of the impact of key information or aspects of the promotional offer they need to determine which aspects of a promotional marketing campaign, if any, should be adjusted in order to effectively enhance future sales of a product during an upcoming fiscal quarter.

In some instances, a demand forecast may not accurately predict a demand for a product if the demand forecast does not consider promotional tactics associated with the product. Based on such a forecast, a business entity (e.g., a retailer) may not be informed of the impact of promotional tactics on the demand.

### BRIEF DESCRIPTION OF THE DRAWINGS

FIG. 1 is a block diagram of a system according to some embodiments.

FIG. 2 is a flow diagram demand forecasting including promotional tactics according to some embodiments.

FIG. 3 is a flow diagram of a process for demand forecasting including promotional tactics according to some embodiments.

FIG. 4 is a block diagram of a system according to some embodiments.

FIG. 5 is a block diagram of a system according to some embodiments.

### DETAILED DESCRIPTION

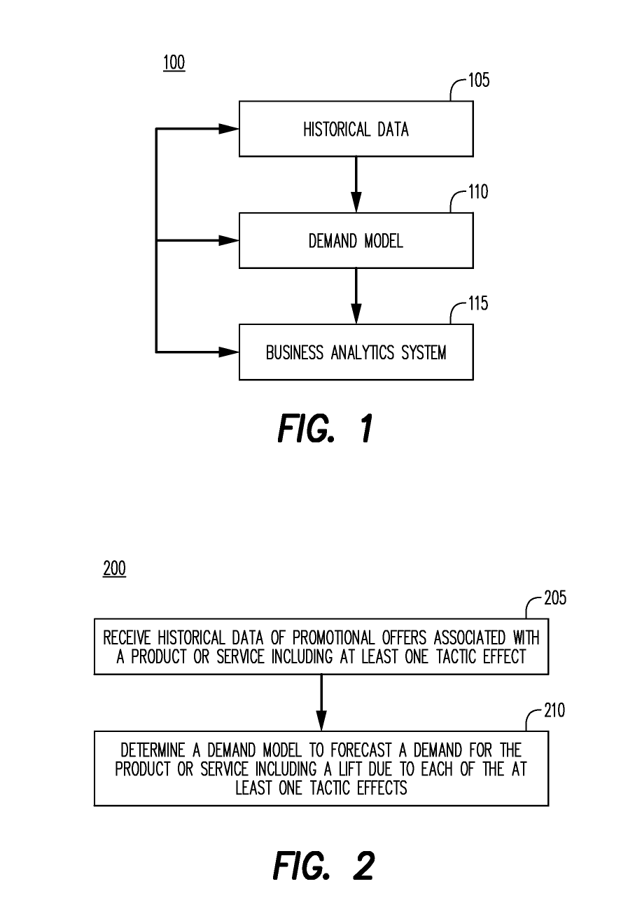

A method, system, and mechanism for efficiently providing a demand model and a demand forecast of promotions with one or more promotional tactics are provided by some embodiments herein. As introduced above, a business entity may desire greater insight into the effect of promotional offers of a demand forecast than that provided by a demand model that only provides an overall demand metric or measure. Accordingly, the demand models and forecasts provided in some embodiments herein (e.g., demand model 110 of FIG. 1) may provide an indication of a lift of the tactic effects associated with promotional offers that drive or otherwise contribute to the forecast generated by the demand model.

FIG. 1 provides aspects of a commerce system 100, in accordance with some embodiments of demand models and demand forecasts herein. As shown, historical data, including in some instances transactional sales data, related to promotional offers used to promote a product or service is provided at operation 105. As used herein, a product may include instances where the product is a service. A product or service may be any products, goods, or services that may be represented as distinct quantifiable “units” for determining a demand for those products, goods, and services. In some embodiments, the units of a demand forecast refer to a quantity of units of the products, goods, of services sold in a particular time period.

The historical data 105 may be received, retrieved, determined, or otherwise obtained by a person, system, or other entity by any method and means now known or that becomes known in the future. In some instances, historical data 105 is provided by one or more entities also associated with commerce system 100 and in some other instances the historical data may be provided by a business service provider that functions to provide the historical data and is not otherwise associated with commerce system 100. In some embodiments, historical data 105 may include one or more of sales data received from retailers, invoiced orders received from distributors, purchase orders received from manufacturers, and other sources.

Based on historical data 105, a demand model may be generated at operation 110. Demand model 110 may be represented as a mathematical expression that provides a predicted or anticipated outcome, based on a given set of input data and assumptions. The input data may be processed through the mathematical expression representing either an expected or current behavior of commerce system 100. The mathematical expression may be derived from and based on principles of probability and statistics, including analyzing historical data 105 and corresponding known outcomes related thereto, to achieve a “best fit” of the expected behavior of the system to other sets of data. In this manner, demand model 110 may predict or forecast a demand for products in commerce system 100. Demand model 110 may generate a forecast sales demand based on a number of considerations, as will be explained in greater detail below, such as a proposed price, type of associated promotion, type of promotional tactic used, tactic details associated with the type of tactic (i.e., tactic type), and other attributes of the subject product.

Business analytics system 115 may include one or more of a manufacturer, distributor, retailer, or other entity of commerce system 100, such as a business service provider or system, that may use demand model 110 to control business decisions and business operations related to commerce system 100. In some embodiments, decisions and actions related to the manufacturing, distribution, and sale of the products associated with commerce system 100 may be made based on a demand forecast provided by demand model 110. In some embodiments, business analytics system 115 may be provided by or on the behalf of the one or more manufacturers, distributors, retailers, or other entities associated with commerce system 100, by means of local, remote, or distributed computer systems (not shown).

In some aspects, business analytics system 115 may further provide historical (transactional) data 105 that is then passed to demand model 110. The data provided to demand model 115 from the business analytics system 110 may be used to dynamically generate updated forecasts predicting the demand for the products of commerce system 100. In some aspects, the entities (e.g., persons and systems) of business analytics system 115 may make adjustments and/or provide inputs to demand model 110 where the inputs operate to adjust the forecasts provided by the demand model. In some embodiments, the demand model(s) 110, may be generated or otherwise tailored for the particular entities of business analytics system 115 that may use them. As such, historical data 105 used by a demand model 110 may be configured to correspond the pertinent aspects of the business analytics system 115.

The communication of forecasts and other data and information between the various aspects of commerce system 100 may be facilitated by electronic communication links, whether the communication links are permanent, ad-hoc, wired, wireless, and a combination thereof. Some embodiments herein are associated with systems and methods for providing a demand forecast that includes an indication of the tactics or tactic effects used in a promotional offering of a product. As used herein, a tactic or tactic effect may refer to a plan or procedure for promoting the product towards a desired result (e.g, more units sold). Some prior retail demand modeling and forecasting approaches may have considered whether a product was actively promoted. However, no consideration was given to key tactical aspects of the promotion with such demand modeling and forecasting approaches. Some key promotional tactics may include, but are not limited to, for example, radio or television commercials, newspaper advertisements or inserts, direct mail advertisements (e.g., flyers), billboard advertisements, in-store signage, in-store special displays (e.g., a special island display in the front of the store), and other tactics.

In some aspects, it may be a goal or effort of some embodiments herein to maximize the accuracy of demand forecasts for promotions. The accuracy of demand forecasts for promotions may be improved by considering and accounting for all tactics for a promotion. An illustrative example will be presented to highlight the impact of considering all of the tactics used in a promotion for a demand forecast. In this example, a product X is to be forecasted for the following weeks, with the promotions as indicated below:
Week 1: price=$10, no promotion;
Week 2: price=$8, promotion with tactics: a radio ad;
Week 3: price=$8, promotion with tactics: an in-store flyer, a radio ad, and an in-store end-cap display

In a traditional demand modeling context, the example weekly promotions listed above that only considered whether a promotion was active or not while ignoring promotional tactics, the demand forecasts for weeks 2 and 3 would be identical since weeks 2 and 3 each include a tactic (albeit different tactics). For example:
Week 1: Forecasted unit sales=1000
Week 2: Forecasted unit sales=2000
Week 3: Forecasted unit sales=2000

However, if demand modeling considered and accounted for the effects from the different tactics disclosed in some embodiments herein, then the accuracy of the demand forecasts can be significantly improved by responding to the specific tactics for each forecasted scenario. Thus, for the present example the forecasts for weeks 2 and 3 may be rather different and more accurate, as compared to the demand forecasts above. As an example, a demand forecast that considers and accounts for each particular tactic may yield:
Week 1: Forecasted unit sales=1000
Week 2: Forecasted unit sales=1500 (considering the radio ad promotion tactic)
Week 3: Forecasted unit sales=2500 (considering the in-store flyer, a radio ad, and an in-store end-cap display promotion tactics)

As disclosed herein, demand modeling that considers promotional tactics may produce forecasts that more accurately predict the impact of a promotion on a demand. Thus, as illustrated by the foregoing example a retailer, manufacturer, or other business entity may effectively assess the impact(s) of a promotion and its tactics on a demand forecast. The knowledge and insight provided by the demand forecast including tactical information may assist the business entity in determining a course of action such as, for example, adding more and/or different promotional tactics of a particular type, variety, and amount (i.e., resources) in an effort to control demand.

FIG. 2 is an example of a flow diagram of a process 200 in accordance with some embodiments herein. At operation 205, historical data related to promotional offers including data of the tactical effects associated with the promotional offers is received at operation 205. The historical data may be received from one of or a combination of retailers, distributors, third party data aggregators, business service providers, and other entities that may generate, process, collect, or otherwise possess historical data reflecting promotional offers and the tactics used in those promotional offers. As indicated at operation 205, the promotional offers may include at least one tactic effect. The at least one tactic effect may include a combination of tactic types and tactic details. In some instances, the tactic effect may include both a tactic type and tactic details, and in some instances the tactic effect may include a tactic type. In the event the historical data received at operation 205 is to be used to determine or generate a demand forecast model including promotional offer tactics, at least one tactic effect will be included in the historical data received at operation 205.

In some embodiments, the historical data received at operation 205 may be received and stored in any data structure. In some embodiments, the historical data may be stored in a relational database table(s), an object-oriented programming language data structure(s), and combinations thereof. In some embodiments, an OFFER table or other data structure including promotional offers is associated with a TACTICS table or other data structure including the tactic effects assigned to the promotional offers. The TACTICS table may specify the tactic type, (e.g., media advertisement), a tactic detail (e.g., radio ad), and an attribute parameter (e.g. expected audience of 10,000) comprising a specific tactic scenario.

For some embodiments, a demand model herein may generally reference an N-level tactic hierarchy. For example, a top level of the hierarchy may reference a set of tactic types (e.g. in-store display, media advertisements, etc.), a second level or next level hierarchy may reference a more detailed specification of the tactic type (e.g., an end-cap display, a radio ad, a print ad, etc.), and additional levels may specify additional attributes of the tactic (e.g., end-cap location 1, end cap location 2, center aisle location, public radio ad, etc.).

Returning to FIG. 2, a demand model to forecast a demand for the product or service including a lift due to all of the at least one tactic effects included in the historical data received at operation 205 is generated. In some embodiments, the demand model may be generated by a computer, a computing device/system, an on-demand software service, or other software application delivering configurations. In general, the demand model generated at operation 210 may generally be expressed mathematically.

Furthermore, in accordance with the present disclosure, the demand model generated at operation 210 may not be limited to a specific mathematical expression. Rather, a key aspect of some demand models herein is that they reflect a tactic type and tactic details assigned to a promotion and provide an output indicative of a lift attributable to the tactic effects associated with the promotion.

In some embodiments of a demand model herein, each combination of Tactic Type and Tactic Details comprises a model tactic ID having a uniquely modeled lift, vₜ. This tactic lift factor, vₜ, may multiply the overall unit sales or transactions to provide an indication of the lift due to the particular model tactic ID for all of the unit sales or transactions subject to the promotion. The tactic lift vₜ may thus be expressed as an adjustment to the unit sales predicted by a unit sales demand model or the number of transactions predicted by a transaction-count demand model. In some embodiments, the promotional lift component of an offer forecast may reflect the total impact of all the Tactic Types,Tactic Details, and Tactic Attributes that have been assigned to the offer. In some aspects, demand modeling and demand forecasting herein may include modeling and forecasting of individual tactics. The modeling and forecasting of individual tactics used by some embodiments herein may facilitate forecasting new combinations of tactics since, for example, the lift of individual tactics comprising the combinations of tactics are known (i.e., modeled and forecast).

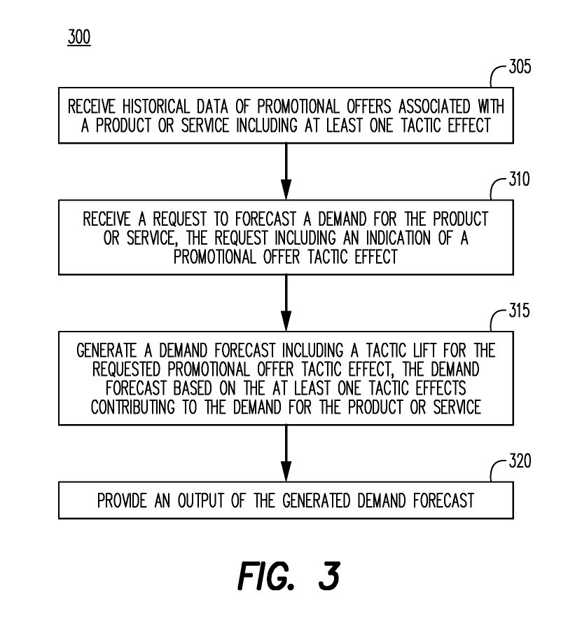

FIG. 3 is an illustrative flow diagram of a process 300, in accordance with aspects of the present disclosure. FIG. 3 includes a process for generating a demand forecast for a product, the demand forecast to account for tactics associated with the promotional offers relating to the product. At operation 305, historical data of promotional offers associated with a product or service including at least one tactic effect may be received. The historical data may be received in a format and configuration that may be read or processed by a computing device or system. In some aspects it may be assumed that the promotional offer related to the product for which a demand forecast is desired includes at least one tactic effect.

At operation 310, a request for a demand forecast is received. The demand forecast may include an indication of the tactic effect to be included in the demand forecast. For example, the demand forecast may include a request that the forecast include a lift due to an in-store display (Tactic Type) where the product is displayed on an end-cap (Tactic Detail).

Operation 315 includes generating a demand forecast including a tactic lift for the requested promotional offer tactical effect. The generated demand forecast is based, at least in part, on the at least one tactic effects of the historical data received at operation 305 that contribute to the demand of the product. The demand forecast may include all of the tactics relevant to the promotion of the subject product.

In some embodiments, the generated demand forecast may be provided in a report or presentation, including texts and/or graphical representations of relative values of the demand components comprising the demand forecast at operation 320. In some embodiments, the generated demand forecast may be presented in a manner, format, and structure that are understood by a person, computer, or system, appropriate to the uses and implementations of the methods and systems disclosed herein.

In some embodiments, it may be assumed or a constraint of some demand forecasting herein that all of the (Tactic Type+Tactic Details) assigned to an offer should be executed or otherwise active in the future. An example of a (Tactic Type +Tactic Details) may include a Print Tactic Type and an In-store Tactic Detail, while another (Tactic Type+Tactic Details) combination may include a Display Tactic Type and an In-Store Tactic Detail. Each different combination of (Tactic Type+Tactic Details) may define a unique Tactic instance. It noted that the lift attributable to an in-store print promotion may yield different results than an in-store display promotion. In an instance all of the (Tactic Type+Tactic Details) associated with promotional offers of a product are not executed or active in the future, then modeled and forecasted tactic lifts for the promotional offers will be inaccurate, with the tactic lifts generally being biased low. For example, in the event that an offer is associated with the tactics of a “flyer” and “television”, the retailer should in fact advertise the offer in a flyer and on television. If the actual executed promotion(s) do not occur, then the modeled and forecasted tactic lifts for the offer will be incorrect (generally biased low).

Likewise, in an instance additional tactics, advertising, or other marketing campaigns are executed or active in the future that are not reflected in the demand modeling and forecasting, then the modeled and forecasted tactic lifts including assigned tactics but not the additional tactics will be inaccurate, with the tactic lifts being generally biased high. As an example, if a retailer assigns a flyer tactic to an offer and executes it, but at the same time of that offer also runs a television ad and locates the product on a special in-store display, then the shopper(s) may respond to the combination of all three tactics even though only one tactic is assigned to the offer. In this instance, the demand modeling and forecasting reflective of only one tactic may appear to attribute the full tactic lift to the flyer tactic since that is only tactic effect considered in the modeling and forecasting.

In some embodiments, it may be assumed or a constraint of some embodiments that all of the tactics assigned to a promotional offer be applied to all product-locations within the offer. That is, in some embodiments tactics may not be added to an offer to only be applied to part of the offer.

In some embodiments herein, a tactic effect may be inherited from similar tactic effects. Based on this inheritance capability of some embodiments herein, demand forecasting of a new tactic effect may be facilitated herein. To illustrate the inheritance of tactic effects, a number of tactic effects may be expressed. For example, tactic effects may include a Tactic Type−Tactic Detail combination, Ty−Td; and a Ty tactic effect that represents a Tactic Type with undefined or initial tactic.

The following table, using the above-naming convention, illustrates a number of scenarios of supported demand modeling and demand forecasting according to some embodiments herein given requested historical offer data (col. 1) and the desired forecasted offer (col. 2).

| Tactic contained | Tactic requested to | |
|---|---|---|
| in Sales History | be Forecasted | Forecasted Demand |
| Ty-Td | Ty-Td | Use lift from Ty-Td |
| Ty-Td | Ty | Inherit lift from Ty |
| Ty | Ty-Td | Inherit lift from Ty |
| Ty | Ty | Use lift from Ty |

As shown in the table, the example scenario of row 1 includes historical offers including Ty−Td tactical information and a request for a demand forecast including a lift due to Ty−Td. In some instances, the requested forecast may not be obtained directly from the historical data as shown in rows 2 and 3. In such instances, the possible demand forecasts of column 3 may be inherited or derived from available historical offer data.

It should be appreciated that the particular tactic effects disclosed herein are not intended to be an exclusive or exhaustive listing of the demand components (i.e., tactic types and tactic details) contemplated and within the scope of the present disclosure. Other, alternative, substitute, fewer, and more tactic effects components should be understood to be within the scope of the present disclosure, including obvious and non-obvious modifications of the example demand components explicitly disclosed herein.

In accordance with aspects herein, some of the disclosed methods may be implemented using any number of programming languages and/or techniques, such as Web Dynpro, Java, the Advanced Business Application Programming (ABAP) language, and other languages. In some embodiments, the initial set of historical data may relate to an enterprise that might store and access business information in a number of different ways. For example, an enterprise might store a substantial amount of information about production, sales, marketing, etc. in one or more database structures created by a business service provider (e.g., SAP AG). The initial set of historical data may be provided to a user in a user interface as the result of the user's request for data related to a particular business function and/or organization. The request may comprise a query of a collection of data.

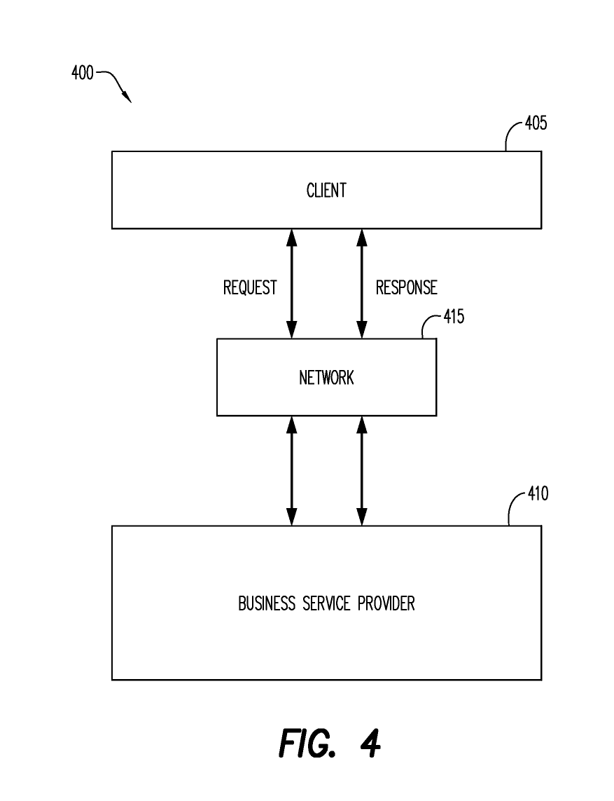

FIG. 4 is a block diagram of a system 400 according to some embodiments. In this case, a business service provider 410 might host and provide business services for a client 405. For example, business service provider 410 may receive requests from the client 405 and provide responses to the client 405 via a service-oriented architecture via a network 415. Note that the business service provider 410 might represent any backend system, including backend systems that belong to the client 405, those that belong to (or are administered by) service providers, those that are web services, etc.

Client 405 may be associated with a Web browser to access services provided by business process platform via HyperText Transport Protocol (HTTP) communication. Client 405, in response, may transmit a corresponding HTTP service request to the business service provider 410 as illustrated. A service-oriented architecture may conduct any processing required by the request (e.g., generating queries related to a demand forecast and executing the queries against a collection of sales data) and, after completing the processing, provides a response (e.g., search results) to client 405. Client 405 may comprise a Personal Computer (PC) or mobile device executing a Web client. Examples of a Web client include, but are not limited to, a Web browser, an execution engine (e.g., JAVA, Flash, Silverlight) to execute associated code in a Web browser, and/or a dedicated standalone application.

In some aspects, FIG. 4 represents a logical architecture for describing processes according to some embodiments, and actual implementations may include more or different elements arranged in other manners. Moreover, each system described herein may be implemented by any number of devices in communication via any number of other public and/or private networks. Two or more of the devices herein may be co-located, may be a single device, or may be located remote from one another and may communicate with one another via any known manner of network(s) and/or a dedicated connection. Moreover, each device may comprise any number of hardware and/or software elements suitable to provide the functions described herein as well as any other functions. Other topologies may be used in conjunction with other embodiments.

All systems and processes discussed herein may be embodied in program code stored on one or more computer-readable media. Such media may include, for example, a floppy disk, a CD-ROM, a DVD-ROM, magnetic tape, and solid state Random Access Memory (RAM) or Read Only Memory (ROM) storage units. According to some embodiments, a memory storage unit may be associated with access patterns and may be independent from the device (e.g., magnetic, optoelectronic, semiconductor/solid-state, etc.) Moreover, in-memory technologies may be used such that databases, etc. may be completely operated in RAM memory at a processor. Embodiments are therefore not limited to any specific combination of hardware and software.

Accordingly, a method and mechanism for efficiently and automatically creating and executing a query based on a selection of data items selected via a user interface are provided by some embodiments herein.

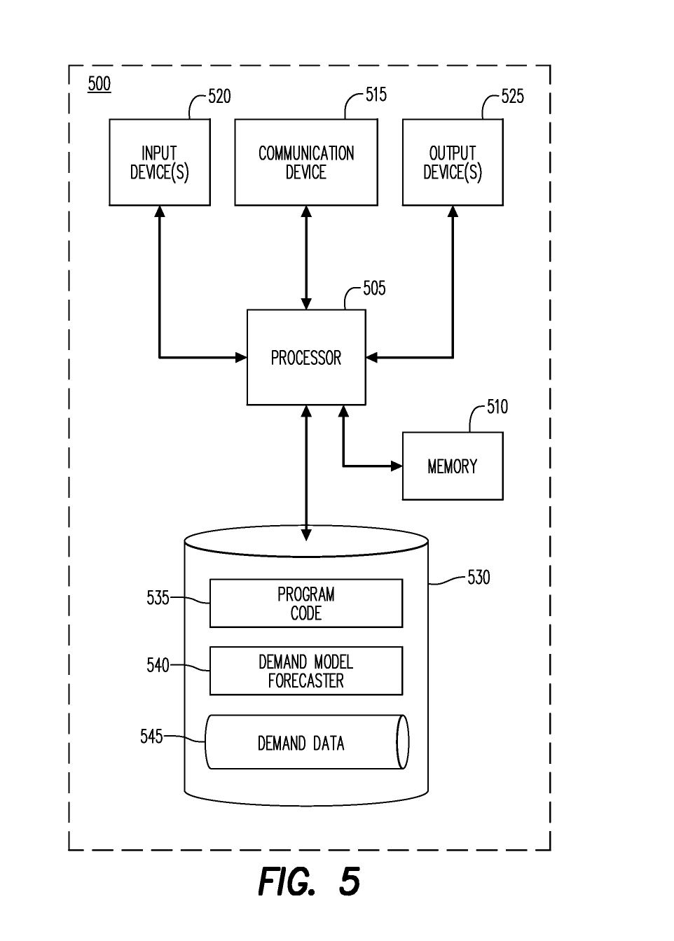

FIG. 5 is a block diagram overview of a system or apparatus 500 according to some embodiments. The system 500 may be, for example, associated with any of the devices described herein, including for example business analytics system 115, client 405, and business service provider 410. The system 500 comprises a processor 505, such as one or more commercially available Central Processing Units (CPUs) in form of one-chip microprocessors or a multi-core processor, coupled to a communication device 815 configured to communicate via a communication network (not shown in FIG. 5) to a front end client (not shown in FIG. 5). Device 500 may also include a local memory 510, such as RAM memory modules. Communication device 515 may be used to communicate, for example, with one or more client devices or business service providers. The system 500 further includes an input device 520 (e.g., a touchscreen, mouse and/or keyboard to enter content) and an output device 525 (e.g., a computer monitor to display a user interface element).

Processor 855 communicates with a storage device 530. Storage device 530 may comprise any appropriate information storage device or medium, including combinations of magnetic storage devices (e.g., a hard disk drive), optical storage devices, and/or semiconductor memory devices.

Storage device 530 stores a program 535 and/or demand model forecaster application 540 for controlling the processor 505 for determining and/or generating demand model forecasts in accordance with the method and processes herein. Processor 505 performs instructions of the programs 535 and 540 and thereby operates in accordance with any of the embodiments described herein. Programs 535 and 540 may be stored in a compressed, uncompiled and/or encrypted format. Programs 535 and 540 may furthermore include other program elements, such as an operating system, a database management system, and/or device drivers used by the processor 505 to interface with peripheral devices.

Embodiments have been described herein solely for the purpose of illustration. Persons skilled in the art will recognize from this description that embodiments are not limited to those described, but may be practiced with modifications and alterations limited only by the spirit and scope of the appended claims.

What is claimed is:

1. A computer-implemented method, the method comprising:
receiving historical data of promotional offers associated with a product or service, the promotional offers including at least one tactic effect;
receiving a request to forecast a demand for the product or service, the request including an indication of a promotional offer tactic effect;
generating, by the computer, a demand forecast including a tactic lift for the requested promotional offer tactic effect, the demand forecast based on the at least one tactic effect contributing to the demand for the product or service; and
providing an output of the generated demand forecast.

2. The method of claim 1, wherein the promotional offers include a plurality of tactic effects.

3. The method of claim 2, wherein each potential combination of the plurality of tactic effects is modeled and forecasted separately.

4. The method of claim 2, wherein each of the plurality of tactic effects is modeled independently of other tactic effects, thereby facilitating forecasting of a new combination of tactics.

5. The method of claim 4, wherein a tactic effect is inherited from similar tactic effects, thereby facilitating a demand forecasting of a new tactic effect.

6. The method of claim 1, wherein the generating of the demand forecast is determined based on demand model including an attribute or strength factor for each tactic effect.

7. The method of claim 1, wherein the generating of the demand forecast is based on demand model including a utilization factor for each tactic effect, the utilization factor indicative of a number of potential promotional locations utilizing the tactic effect.

8. The method of claim 1, wherein the at least one tactic effect includes a tactic type and a tactic detail.

9. A system, comprising:
a memory having program instructions stored thereon; and
a processor in communication with the memory, the processor being operative to:
receive historical data of promotional offers associated with a product or service, the promotional offers including at least one tactic effect;
receive a request to forecast a demand for the product or service, the request including an indication of a promotional offer tactic effect;
generate, by the computer, a demand forecast including a tactic lift for the requested promotional offer tactic effect, the demand forecast based on the at least one tactic effect contributing to the demand for the product or service; and
provide an output of the generated demand forecast.

10. The system of claim 9, wherein the promotional offers include a plurality of tactic effects.

11. The system of claim 9, wherein each potential combination of the plurality of tactic effects is modeled and forecasted separately.

12. The system of claim 9, wherein each of the plurality of tactic effects is modeled independently of other tactic effects, thereby facilitating forecasting of a new combination of tactics.

13. The system of claim 12, wherein a tactic effect is inherited from similar tactic effects, thereby facilitating a demand forecasting of a new tactic effect.

14. The system of claim 9, wherein the generating of the demand forecast is determined based on demand model including an attribute or strength factor for each tactic effect.

15. The system of claim 9, wherein the generating of the demand forecast is based on demand model including a utilization factor for each tactic effect, the utilization factor indicative of a number of potential promotional locations utilizing the tactic effect.

16. The system of claim 9, wherein the at least one tactic effect includes a tactic type and a tactic detail.

17. A non-transitory medium having executable program instructions stored thereon, the medium comprising:
program instructions to receive historical data of promotional offers associated with a product or service, the promotional offers including at least one tactic effect;
program instructions to receive a request to forecast a demand for the product or service, the request including an indication of a promotional offer tactic effect;
program instructions to generate a demand forecast including a tactic lift for the requested promotional offer tactic effect, the demand forecast based on the at least one tactic effect contributing to the demand for the product or service; and
program instructions to provide an output of the generated demand forecast.

18. The medium of claim 17, wherein the promotional offers include a plurality of tactic effects.

19. The medium of claim 17, wherein each potential combination of the plurality of tactic effects is modeled and forecasted separately.

20. The medium of claim 17, wherein each of the plurality of tactic effects is modeled independently of other tactic effects, thereby facilitating forecasting of a new combination of tactics.

21. The medium of claim 20, wherein a tactic effect is inherited from similar tactic effects, thereby facilitating a demand forecasting of a new tactic effect.

22. The medium of claim 17, wherein the generating of the demand forecast is determined based on demand model including an attribute or strength factor for each tactic effect.

23. The medium of claim 17, wherein the at least one tactic effect includes a tactic type and a tactic detail.
